(19) United States
(12) Patent Application Publication
(10) Pub. No.: US 2026/0136442 A1
(43) Pub. Date: May 14, 2026

(54) LED Lighting Device

(71) Applicant: Guangzhou Ting Shen Electric Co., Ltd, Guangzhou (CN)

(72) Inventor: Chia-Chun Wang, Guangzhou (CN)

(21) Appl. No.: 19/006,350

(22) Filed: Dec. 31, 2024

(30) Foreign Application Priority Data
Nov. 12, 2024 (CN) 202411615741.0

(51) Int. Cl. H05B 45/42

(52) U.S. Cl. CPC H05B 45/42

(57) ABSTRACT

An LED lighting device comprises a light string composed of series-connected bi-directional LED beads, an AC input terminal supplying AC power to the light string, and a voltage reduction device located at one end of the light string. The voltage reduction device is a polyester film capacitor C1. By utilizing the combination of the light string composed of series-connected bi-directional LED beads and the voltage reduction device, AC power input can be directly used without rectification, resulting in a flicker-free light source. The LED bead pins are not subject to electrolytic effects, enhancing product safety and service life. Because the light beads are arranged in a bi-directional LED configuration, the heat dissipation area is larger, leading to improved heat dissipation and extended LED bead lifespan. The positive and negative half-waves of the AC power are effectively utilized, resulting in a higher power factor for the product.

### CROSS REFERENCE TO RELATED APPLICATIONS

The present application claims the benefit of Chinese Patent Application No. 202411615741.0 filed on Nov. 12, 2024, the contents of which are incorporated herein by reference in their entirety.

### TECHNICAL FIELD

The present invention pertains to the field of LED technology, specifically an LED lighting device with AC input.

### BACKGROUND ART

As shown in FIG. 1, existing LED light products comprise a light string composed of unidirectional LED beads connected in series, a head plug at one end of the light string, and a tail plug at the other end. The AC input is rectified by diodes and combined with a capacitive voltage reduction, supplying only the positive half-wave to the light string. Due to the fixed DC direction, the current remains constant, meeting electrolytic requirements. Electrolysis products accumulate, leading to potential product damage, performance degradation, short circuits, and safety risks such as electrolytic arcing and overheating. Existing products require rectification, which increases costs due to the need for additional diodes, and LED light sources often flicker.

### SUMMARY OF THE INVENTION

The technical problem addressed by this invention is to provide an LED lighting device that eliminates the need for diode rectification, reduces costs, prevents accumulation of electrolytic products, and ensures that the LED light source does not flicker.

To solve the above technical problem, the invention proposes an LED lighting device that comprises a light string composed of bi-directional LED beads connected in series, an AC input terminal for supplying AC power to the light string, and a voltage reduction device located at one end of the light string. The voltage reduction device is a polyester film capacitor C1. The principle of the invention: By using a combination of a light string composed of bi-directional LED beads connected in series and a voltage reduction device, AC input can be used directly without rectification, achieving an un-flickering light source. The direct use of AC input without rectification prevents electrolytic effects on LED bead pins, enhancing product safety and lifespan. The absence of rectification components simplifies the production process and reduces costs. The bi-directional LED beads provide a larger heat dissipation area, improving cooling performance and extending the lifespan of the LED beads. Both the positive and negative half-waves of the AC input are effectively utilized, increasing the power factor of the product.

As an improvement, a voltage reduction resistor is replaced by the polyester film capacitor C1.

As an improvement, the polyester film capacitor C1 is connected in parallel with a discharge resistor R1.

As an improvement, the polyester film capacitor C1 and discharge resistor R1 are connected in parallel, and then connected to one end of the light string through a surge resistor R2, with the other end of the light string connected to a surge resistor R3.

As an improvement, the AC input terminal comprises a live wire L and a neutral wire N, with the live wire L connected to one end of the light string through a fuse FUSE2 and the neutral wire N connected to the other end of the light string through a fuse FUSE1.

As an improvement, the bi-directional LED bead is composed of a pair of light-emitting diodes connected in parallel and in opposite directions, and wherein the LED bead pins are made of Dumet wire.

As an improvement, the LED lighting device also comprises a head plug at one end of the light string and a tail plug at the other end, with the head plug having contact tabs and the tail plug having a first socket with a first contact piece that corresponds to and is electrically connected to the contact tabs.

As an improvement, the voltage reduction device is located on the light string, the head plug, or the tail plug.

As an improvement, the rear end of the head plug is equipped with a second socket containing a second contact piece electrically connected to the contact tabs.

Compared to existing technology, the advantages of this invention are:
1. The combination of a light string composed of bi-directional LED beads and a voltage reduction device allows direct use of AC input without rectification, achieving an un-flickering light source;
2. Direct use of AC input without rectification prevents electrolytic effects on LED bead pins, enhancing product safety and lifespan;
3. Direct use of AC input without rectification and without the need for diodes simplifies the production process and lowers costs;
4. The bi-directional LED configuration of light beads increases the heat dissipation area, improving cooling performance and extending LED lifespan;
5. Direct use of AC input without rectification allows for effective utilization of both the positive and negative half-waves of AC, increasing the power factor, which approaches 1;
6. Using a polyester film capacitor as the voltage reduction element generates less heat compared to resistor-based voltage reduction;
7. LED bead pins made of Dumet wire prevent electrolysis and oxidation.

### DESCRIPTION OF THE DRAWINGS

FIG. 1 is the circuit diagram of the prior art;

FIG. 2 is the circuit diagram of Embodiment 1;

FIG. 3 is the circuit diagram of Embodiment 2;

FIG. 4 is the circuit diagram of Embodiment 3;

FIG. 5 is the circuit diagram of Embodiment 4;

FIG. 6 is the circuit diagram of Embodiment 5.

### DETAILED DESCRIPTION

The present invention is further described in conjunction with the accompanying figures.

### Embodiment 1

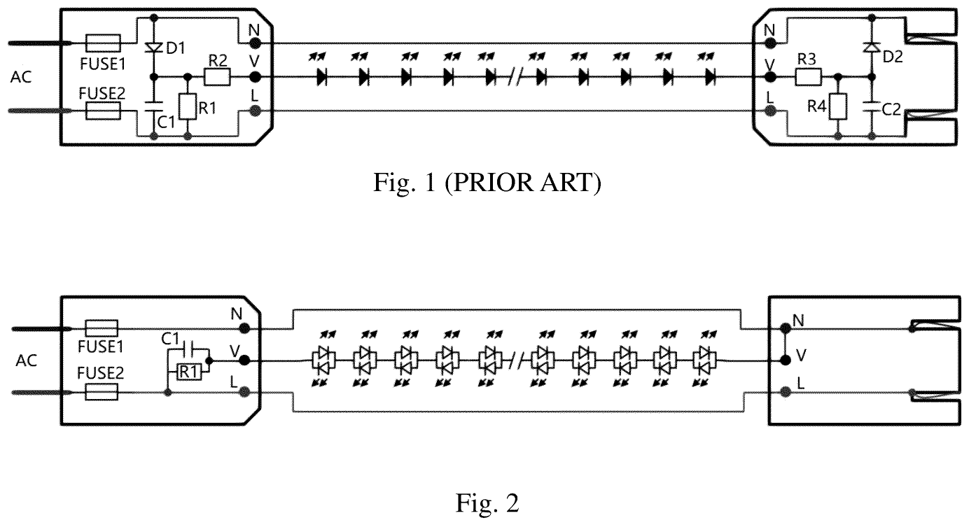

As shown in FIG. 2, an LED lighting device suitable for festival decorations comprises a light string, a head plug installed at one end of the light string, and a tail plug installed at the other end of the light string.

The light string is composed of bi-directional LED beads connected in series. Each bi-directional LED bead consists of a pair of light-emitting diodes connected in parallel and in opposite directions (forward and reverse). During each half-cycle of alternating current, only one light-emitting diode operates, with the two light-emitting diodes alternating operation. This ensures effective utilization of both the positive and negative half-waves of the AC power, resulting in a higher power factor, close to 1. Without the need for rectification, this design achieves an un-flickering light source. The periodic nature of the AC power causes electrode switching, preventing stable electrolytic reactions and protecting the LED bead pin from electrolysis, thereby enhancing product safety and lifespan. The absence of the number of components such as diodes simplifies the production process and lowers product costs. Additionally, due to the bi-directional LED configuration of the light beads, the heat dissipation area is doubled compared to traditional LED beads, leading to improved heat dissipation and an extended lifespan of the LED beads. The pins of the LED beads are made of Dumet wire, which resists electrolysis and oxidation.

One end of the light string is equipped with a step-down device, which, in this embodiment, is a polyester film capacitor C1. The polyester film capacitor C1 is connected in parallel with a discharge resistor R1 and mounted on the same PCB board. The step-down device is housed within the head plug. The capacitor C1 achieves voltage reduction through capacitive reactance, generating resistance to step down the voltage. Using a polyester film capacitor as the step-down component produces less heat compared to resistive voltage reduction. The discharge resistor R1 serves to discharge the polyester film capacitor C1.

The light string has an AC input terminal, which supplies power to the light string after voltage reduction by the step-down device. The AC input terminal comprises a live wire L and a neutral wire N. The live wire L is connected to one end of the light string through fuse FUSE2 and the step-down device, while the neutral wire N is connected to the other end of the light string through fuse FUSE1.

The front end of the head plug is equipped with two tabs corresponding to the live wire L and neutral wire N, and the tail plug has two first insertion holes containing first contact tabs. The tabs and first contact tabs correspond to each other and are electrically connected, allowing the LED lighting device to be used individually or connected in series with another LED lighting device by interlocking the head plug and tail plug.

### Embodiment 2

As shown in FIG. 3, an LED lighting device suitable for festival decorations comprises a light string, a head plug installed at one end of the light string, and a tail plug installed at the other end of the light string.

The light string is composed of bi-directional LED beads connected in series. Each bi-directional LED bead consists of a pair of light-emitting diodes connected in parallel and in opposite directions (forward and reverse). During each half-cycle of alternating current, only one light-emitting diode operates, with the two light-emitting diodes alternating operation. This ensures effective utilization of both the positive and negative half-waves of the AC power, resulting in a higher power factor, close to 1. Without the need for rectification, this design achieves an un-flickering light source. The periodic nature of the AC power causes electrode switching, preventing stable electrolytic reactions and protecting the LED bead pin from electrolysis, thereby enhancing product safety and lifespan. The absence of the number of components such as diodes simplifies the production process and lowers product costs. Additionally, due to the bi-directional LED configuration of the light beads, the heat dissipation area is doubled compared to traditional LED beads, leading to improved heat dissipation and an extended lifespan of the LED beads. The pins of the LED beads are made of Dumet wire, which resists electrolysis and oxidation.

One end of the light string is equipped with a step-down device, which, in this embodiment, is a polyester film capacitor C1. The polyester film capacitor C1 is connected in parallel with a discharge resistor R1 and mounted on the same PCB board. The step-down device is housed within the tail plug. The capacitor C1 achieves voltage reduction through capacitive reactance, generating resistance to step down the voltage. Using a polyester film capacitor as the step-down component produces less heat compared to resistive voltage reduction. The discharge resistor R1 serves to discharge the polyester film capacitor C1.

The light string has an AC input terminal, which supplies power to the light string after voltage reduction by the step-down device. The AC input terminal comprises a live wire L and a neutral wire N. The live wire L is connected to one end of the light string through fuse FUSE2 and the step-down device, while the neutral wire N is connected to the other end of the light string through fuse FUSE1.

The front end of the head plug is equipped with two tabs corresponding to the live wire L and neutral wire N, and the tail plug has two first insertion holes containing first contact tabs. The tabs and first contact tabs correspond to each other and are electrically connected, allowing the LED lighting device to be used individually or connected in series with another LED lighting device by interlocking the head plug and tail plug. The rear end of the head plug features second insertion holes, each with a second contact piece that is electrically connected to the plug blades. Specifically, the live wire L connects to one plug blade, one first contact piece, one second contact piece, and the voltage-reducing device, while the neutral wire N connects to another plug blade, one first contact piece, and one second contact piece.

The neutral wire N at the head plug is drawn out through a wire to a connector, which outputs two wires. These two wires are connected to one end of the light string and to the first contact piece of the tail plug.

### Embodiment 3

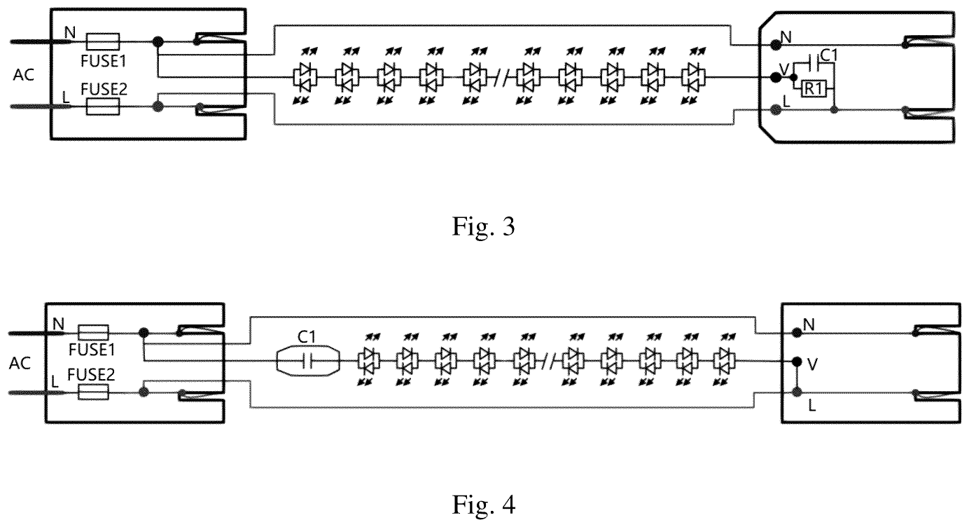

As shown in FIG. 4, an LED lighting device designed for use in festive lighting comprises a light string, a head plug positioned at one end of the light string, and a tail plug located at the opposite end of the light string.

The light string is composed of bi-directional LED beads connected in series. Each bi-directional LED bead consists of a pair of light-emitting diodes connected in parallel and in opposite directions (forward and reverse). During each half-cycle of alternating current, only one light-emitting diode operates, with the two light-emitting diodes alternating operation. This ensures effective utilization of both the positive and negative half-waves of the AC power, resulting in a higher power factor, close to 1. Without the need for rectification, this design achieves an un-flickering light source. The periodic nature of the AC power causes electrode switching, preventing stable electrolytic reactions and protecting the LED bead pin from electrolysis, thereby enhancing product safety and lifespan. The absence of the number of components such as diodes simplifies the production process and lowers product costs. Additionally, due to the bi-directional LED configuration of the light beads, the heat dissipation area is doubled compared to traditional LED beads, leading to improved heat dissipation and an extended lifespan of the LED beads. The pins of the LED beads are made of Dumet wire, which resists electrolysis and oxidation.

One end of the light string is equipped with a step-down device, which, in this embodiment, is a polyester film capacitor C1. The step-down device is positioned near the head plug on the light string and is insulated with a protective wrap. The capacitor C1 achieves voltage reduction through capacitive reactance, generating resistance to step down the voltage. Using a polyester film capacitor as the step-down component produces less heat compared to resistive voltage reduction.

The light string features an AC input terminal, supplying power to the light string after voltage reduction. The AC input terminal comprises a live wire L and a neutral wire N. The live wire L connects to one end of the light string via fuse FUSE2, while the neutral wire N connects to the other end of the light string through fuse FUSE1 and the voltage reduction device.

The front end of the head plug is equipped with two tabs corresponding to the live wire L and neutral wire N, and the tail plug has two first insertion holes containing first contact tabs. The tabs and first contact tabs correspond to each other and are electrically connected, allowing the LED lighting device to be used individually or connected in series with another LED lighting device by interlocking the head plug and tail plug. The rear end of the head plug features second insertion holes, each with a second contact piece that is electrically connected to the plug blades. Specifically, the live wire L connects to one plug blade, one first contact piece, one second contact piece, and the voltage-reducing device, while the neutral wire N connects to another plug blade, one first contact piece, and one second contact piece.

### Embodiment 4

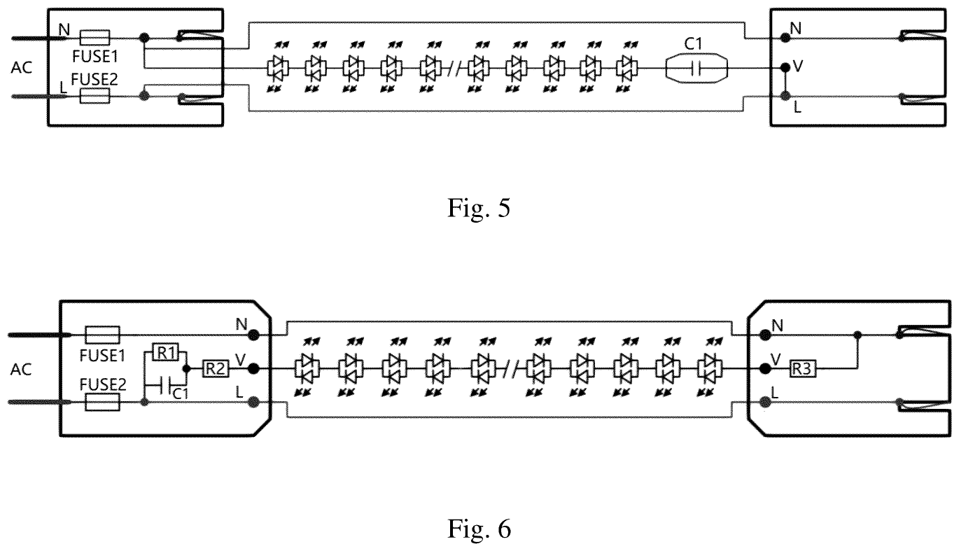

As shown in FIG. 5, an LED lighting device, which can be used for festive lighting, comprises a light string, a head plug positioned at one end of the light string, and a tail plug positioned at the other end.

The light string is composed of bi-directional LED beads connected in series. Each bi-directional LED bead consists of a pair of light-emitting diodes connected in parallel and in opposite directions (forward and reverse). During each half-cycle of alternating current, only one light-emitting diode operates, with the two light-emitting diodes alternating operation. This ensures effective utilization of both the positive and negative half-waves of the AC power, resulting in a higher power factor, close to 1. Without the need for rectification, this design achieves an un-flickering light source. The periodic nature of the AC power causes electrode switching, preventing stable electrolytic reactions and protecting the LED bead pin from electrolysis, thereby enhancing product safety and lifespan. The absence of the number of components such as diodes simplifies the production process and lowers product costs. Additionally, due to the bi-directional LED configuration of the light beads, the heat dissipation area is doubled compared to traditional LED beads, leading to improved heat dissipation and an extended lifespan of the LED beads. The pins of the LED beads are made of Dumet wire, which resists electrolysis and oxidation.

One end of the light string is equipped with a step-down device, which, in this embodiment, is a polyester film capacitor C1. The step-down device is positioned near the tail plug on the light string and is insulated with a protective wrap. The capacitor C1 achieves voltage reduction through capacitive reactance, generating resistance to step down the voltage. Using a polyester film capacitor as the step-down component produces less heat compared to resistive voltage reduction.

The light string has an AC input terminal, which supplies power to the light string after voltage reduction by the step-down device. The AC input terminal comprises a live wire L and a neutral wire N. The live wire L is connected to one end of the light string through fuse FUSE2 and the step-down device, while the neutral wire N is connected to the other end of the light string through fuse FUSE1.

The front end of the head plug is equipped with two tabs corresponding to the live wire L and neutral wire N, and the tail plug has two first insertion holes containing first contact tabs. The tabs and first contact tabs correspond to each other and are electrically connected, allowing the LED lighting device to be used individually or connected in series with another LED lighting device by interlocking the head plug and tail plug. The rear end of the head plug features second insertion holes, each with a second contact piece that is electrically connected to the plug blades. Specifically, the live wire L connects to one plug blade, one first contact piece, one second contact piece, and the voltage-reducing device, while the neutral wire N connects to another plug blade, one first contact piece, and one second contact piece.

### Embodiment 5

As shown in FIG. 6, an LED lighting device designed for use as holiday decorations is described. This device comprises a string of lights, a head plug located at one end of the light string, and a tail plug at the other end.

The light string is composed of bi-directional LED beads connected in series. Each bi-directional LED bead consists of a pair of light-emitting diodes connected in parallel and in opposite directions (forward and reverse). During each half-cycle of alternating current, only one light-emitting diode operates, with the two light-emitting diodes alternating operation. This ensures effective utilization of both the positive and negative half-waves of the AC power, resulting in a higher power factor, close to 1. Without the need for rectification, this design achieves an un-flickering light source. The periodic nature of the AC power causes electrode switching, preventing stable electrolytic reactions and protecting the LED bead pin from electrolysis, thereby enhancing product safety and lifespan. The absence of the number of components such as diodes simplifies the production process and lowers product costs. Additionally, due to the bi-directional LED configuration of the light beads, the heat dissipation area is doubled compared to traditional LED beads, leading to improved heat dissipation and an extended lifespan of the LED beads. The pins of the LED beads are made of Dumet wire, which resists electrolysis and oxidation.

One end of the light string is equipped with a step-down device, which, in this embodiment, is a polyester film capacitor C1. The polyester film capacitor C1 is connected in parallel with a discharge resistor R1 and then connected to one end of the light string through an anti-surge resistor R2. The other end of the light string is connected to anti-surge resistor R3. The polyester film capacitor C1, discharge resistor R1, and anti-surge resistor R2 are mounted on the same PCB board, and the voltage reduction device is housed within the head plug. The step-down device is housed in the head plug and the anti-surge resistor R3 is located within the tail plug. The capacitor C1 achieves voltage reduction through capacitive reactance, generating resistance to step down the voltage. Using a polyester film capacitor as the step-down component produces less heat compared to resistive voltage reduction. The discharge resistor R1 serves to discharge the polyester film capacitor C1, while the anti-surge resistors R2 and R3 protect the LED beads.

The light string has an AC input terminal, and after the voltage is reduced by the voltage reduction device, the AC power supplies the light string. The AC input terminal comprises a live wire L and a neutral wire N. The live wire L is connected to one end of the light string through a fuse FUSE2, the voltage reduction device, and anti-surge resistor R2. The neutral wire N is connected to the other end of the light string through a fuse FUSE1 and anti-surge resistor R3.

The front end of the head plug is equipped with two tabs corresponding to the live wire L and neutral wire N, and the tail plug has two first insertion holes containing first contact tabs. The tabs and first contact tabs correspond to each other and are electrically connected, allowing the LED lighting device to be used individually or connected in series with another LED lighting device by interlocking the head plug and tail plug.

What is claimed is:

1. An LED lighting device comprising:
a light string composed of bi-directional LED beads connected in series;
an AC input terminal for supplying AC power to the light string; and
a voltage reduction device located at one end of the light string, the voltage reduction device is a polyester film capacitor C1.

2. The LED lighting device as recited in claim 1, wherein a voltage reduction resistor is replaced by the polyester film capacitor C1.

3. The LED lighting device as recited in claim 1, wherein the polyester film capacitor C1 is connected in parallel with a discharge resistor R1.

4. The LED lighting device as recited in claim 2, wherein the polyester film capacitor C1 and discharge resistor R1 are connected in parallel, and then connected to one end of the light string through a surge resistor R2, with the other end of the light string connected to a surge resistor R3.

5. The LED lighting device as recited in claim 1, wherein the AC input terminal comprises a live wire L and a neutral wire N, with the live wire L connected to one end of the light string through a fuse FUSE2 and the neutral wire N connected to the other end of the light string through a fuse FUSE1.

6. The LED lighting device as recited in claim 1, wherein the bi-directional LED bead is composed of a pair of light-emitting diodes connected in parallel and in opposite directions, and wherein the LED bead pins are made of Dumet wire.

7. The LED lighting device as recited in claim 1, wherein the LED lighting device also comprises a head plug at one end of the light string and a tail plug at the other end, with the head plug having contact tabs and the tail plug having a first socket with a first contact piece that corresponds to and is electrically connected to the contact tabs.

8. The LED lighting device as recited in claim 7, wherein the voltage reduction device is located on the light string, the head plug, or the tail plug.

9. The LED lighting device as recited in claim 7, wherein the rear end of the head plug is equipped with a second socket containing a second contact piece electrically connected to the contact tabs.
